(19) United States
(12) Patent Application Publication
(10) Pub. No.: US 2022/0081057 A1
(43) Pub. Date: Mar. 17, 2022

(54) Modular Biking Device

(71) Applicant: Wilfried Dreyfuss, Honolulu, HI (US)

(72) Inventor: Wilfried Dreyfuss, Honolulu, HI (US)

(21) Appl. No.: 17/199,097

(22) Filed: Mar. 11, 2021

Related U.S. Application Data
(60) Provisional application No. 63/079,477, filed on Sep. 17, 2020.

(51) Int. Cl. B62K 13/04; B62M 19/00

(52) U.S. Cl. CPC B62K 13/04; B62M 19/00

(57) ABSTRACT

The modular bike is a chainless biking device that may be quickly converted from a road bike to an all-off-the-road bike or a racing bike. To accomplish this, the device includes a frame, a drive box, and a plurality of wheels that are detachably attached to one another in an efficient and stable fashion. The device utilizes a hydraulic drive mechanism, which is more efficient than a chain drive mechanism. Further, a quick release mechanism associated with the wheel hubs of the modular bike enable users to quickly change the wheels from the frame for tire and/or spoke repairs. Additionally, the offset arrangement of the drive box and the frame along with the quick release mechanism of the wheels enable users to transform the bike to various configurations to match to the purpose/terrain of the ride etc.

The current application claims a priority to the U.S. Provisional Patent application Ser. No. 63/079,477 filed on Sep. 17, 2020.

### FIELD OF THE INVENTION

This invention relates to bicycles. More particularly, the present invention relates to a modular bicycle with a hydraulic chainless driving mechanism and quick-change components.

### BACKGROUND OF THE INVENTION

The invention of the bicycle has had an enormous effect on society, both in terms of culture and of advancing modern industrial methods. A bicycle, also called a bike or cycle, is a human-powered or motor-powered, pedal-driven, single-track vehicle, having two wheels attached to a frame, one behind the other. Bicycles are riders' principal means of transportation in many regions of the world. They also provide a popular form of recreation, and have been adapted for use as children's toys, for general fitness, military and police applications, courier services, bicycle racing, and bicycle stunts. Additionally, it can save a large amount of gasoline during times of high fuel prices. While bicycle technology has changed much over the years, one basic aspect which has not is the chain and sprocket system used to transfer the mechanical energy from the rider's legs to the bicycle wheel. Such drive systems are complicated and prone to mechanical failure, difficulty in accessing the desired gear, difficulty in changing the tires, limited discrete gear ratios, and are potentially dangerous should an article of clothing or an extremity become caught in the chain. Accordingly, and in light of the foregoing, there exists a need for means by which an alternative method of bicycle propulsion can be provided which addresses the deficiencies as described above.

It is an objective of the present invention to provide users with a modular bike, that may be quickly converted from a road bike to an all-off-the-road bike or a racing bike. To accomplish this, the present invention comprises a frame, a drive box, and a plurality of wheels that are detachably attached to one another in an efficient and stable fashion. A preferred embodiment of the present invention utilizes a hydraulic driving mechanism, which is more efficient than a chain drive mechanism and has a variable speed function. Further, the system includes fewer parts and offers more reliability than the traditional bicycle. Furthermore, a quick release mechanism associated with the wheel hubs of the present invention enable users to quickly change the wheels from the frame for tire and/or spoke repairs. Additionally, an offset arrangement of the drive box and the frame along with the quick release mechanism of the wheels enable users to transform the bike to various configurations to match to the purpose/terrain of the ride etc. Thus, the present invention is a chain-free modular bike that is efficient, versatile, and easy to maintain.

### BRIEF DESCRIPTION OF THE DRAWINGS

FIG. 1 is a top-front-left perspective view of the present invention, wherein a single back wheel is mounted to a frame and a bent drive box.

FIG. 2 is a bottom plane view of the present invention, wherein a single back wheel is mounted to a bent drive box.

FIG. 3 is a top-front-left perspective view of a tricycle configuration, of the present invention.

FIG. 4 is a bottom plane view of a tricycle configuration, of the present invention.

FIG. 5 illustrates a side view of the back section of the present invention, wherein the drive box is positioned in between the frame and the wheel.

FIG. 6 is an exploded side view of FIG. 5.

FIG. 7 is a top perspective view of a drive box shown in phantom, wherein the pedals are attached to a hydraulic pump in the front, and a hydraulic motor with two axels protruding out of the drive box are shown towards the rear end of the drive box.

### DETAIL DESCRIPTIONS OF THE INVENTION

All illustrations of the drawings are for the purpose of describing selected versions of the present invention and are not intended to limit the scope of the present invention.

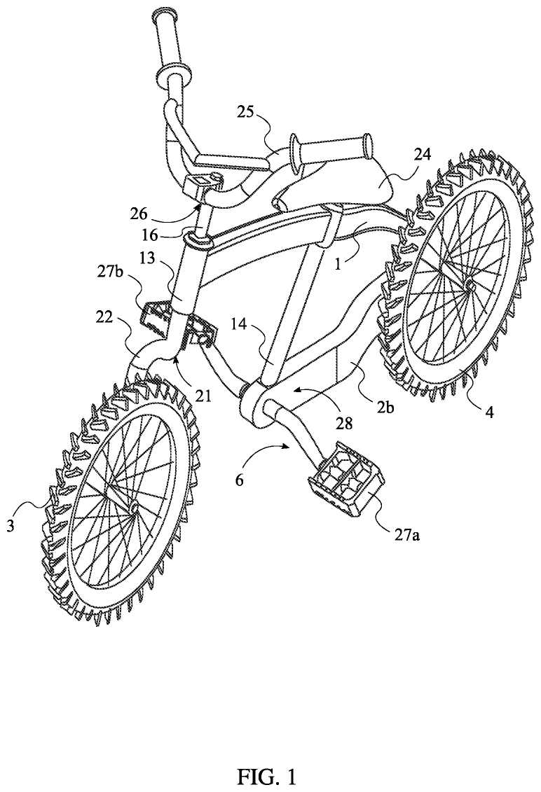

In reference to FIG. 1 through FIG. 7, the present invention is a modular bike. It is an objective of the present invention to provide users with a modular bike, that may be quickly converted from a road bike to an all-off-the-road bike or a racing bike. To accomplish this, the present invention comprises a frame, a drive box, and a plurality of wheels that are detachably attached to one another in an efficient and stable fashion. A preferred embodiment of the present invention utilizes a hydraulic drive mechanism, which is more efficient than a chain drive mechanism and has a variable speed function. Further, the system includes fewer parts and offers more reliability than the traditional bicycle. Furthermore, a quick release mechanism associated with the wheel hubs of the present invention enable users to quickly change the wheels from the frame for tire and/or spoke repairs. Additionally, an offset arrangement of the drive box and the frame along with the quick release mechanism of the wheels enable users to transform the bike to various configurations to match to the purpose/terrain of the ride etc. Thus, the present invention is a chain-free modular bike that is efficient, versatile, and easy to maintain.

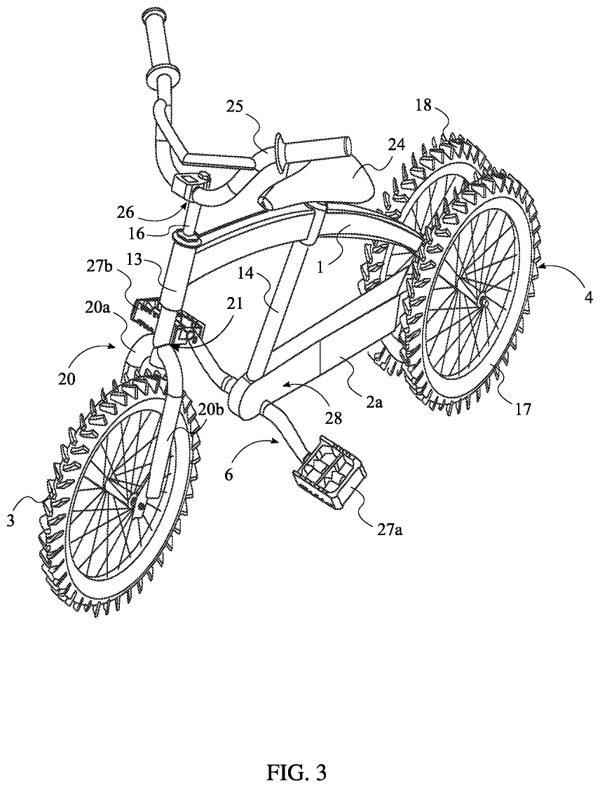

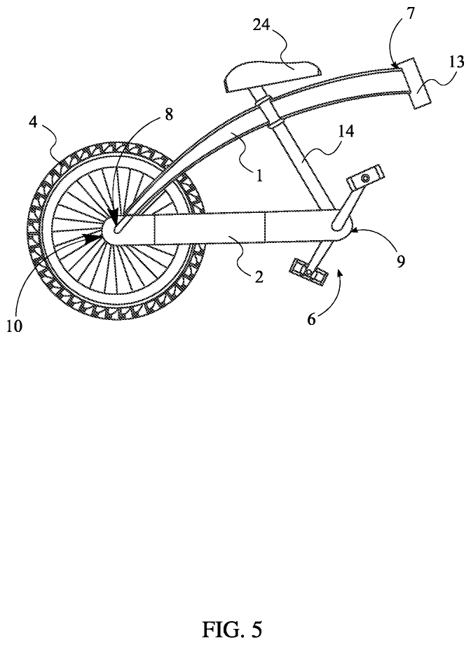

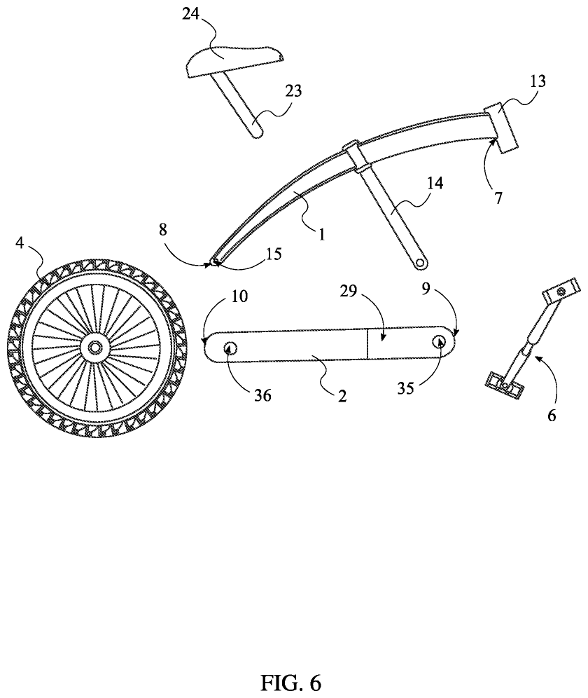

The following description is in reference to FIG. 1 through FIG. 7. According to a preferred embodiment, the present invention comprises a frame 1, a drive box 2, at least one front wheel 3, at least one rear wheel 4, a driving mechanism 5, and a plurality of pedals 6. In the preferred embodiment, the frame 1 is manufactured by existing methods of production. Additionally, the frame 1 may be selected and designed on a computer with any futuristic form (style) of construction and in multiple colors. As seen in FIG. 1, FIG. 3, FIG. 5, and FIG. 6, the frame 1 comprises a tubular curved structure. However, the frame 1 may comprise any other shape, size, orientation, components, and arrangement of components that are known to one of ordinary skill in the art, as long as the objectives of the present invention are fulfilled.

As seen in FIG. 1 through FIG. 6, the drive box 2 is detachably connected between the frame 1 and the at least one rear wheel 4. This is because, unlike normal biking devices, the frame 1 and the drive box 2 of the present invention are manufactured as separate units in a housing. Only by connecting the frame 1 and the drive box 2 together, will the modular bike have a stable center structure. Further, the at least one front wheel 3 is detachably mounted to a first end 7 of the frame 1 and the at least one rear wheel 4 is detachably mounted onto a second end 8 of the frame 1, opposite to the front wheel 3. Furthermore, it is preferred that the modular biking device has quick change mechanisms. To that end, the at least one rear wheel 4 and the at least one front wheel 3 are connected to the frame 1 by means of a quick release fastening mechanism, that enables the wheels to be quickly replaced with one hand. However, the frame 1, the drive box 2, and the at least one rear wheel 4 may be connected any other fastening method or technique that is known to one of ordinary skill in the art, as long as the intents of the present invention are not altered. Examples of which include, but are not limited to, a quick-change connection, a plugin connection, a screw-together connection, a flange-connection, or a welding connection.

As seen in FIG. 1 through FIG. 7, the drive box 2 is a thin enclosed structure having an oblong shape and spanning a few centimeters in width. However, the drive box 2 may comprise any other size, shape, components and arrangement of components that are known to one of ordinary skill in the art, as long as the intents of the present invention are not hindered. According to the preferred embodiment, the driving mechanism 5 is mounted within the drive box 2. Preferably the driving mechanism 5 is hydraulic, making the present invention a hydraulic modular bike. The hydraulic modular bike is useful to prevent mechanical failure and difficulty in accessing the desired gear. The hydraulic modular bike is further useful for reducing difficulty in changing a rear tire and having limited discrete gear ratios. Furthermore, the hydraulic modular bike helps to prevent potentially dangerous accidents should an article of clothing or an extremity become caught in the chain. Additionally, the hydraulic modular biking device reduces the complexity of a conventional bicycle. However, any other driving mechanism 5 that is known to one of ordinary skill in the art may be mounted within the drive box 2, as long as the objectives of the present invention are not altered. Examples of which include, but are not limited to an electric, magnetic, hybrid, gearless, battery operated etc.

According to the preferred embodiment, the present invention is a pedal driven modular bike. For enabling a smooth biking experience and transfer of energy between various components, the plurality of pedals 6 is detachably mounted adjacent a first end 9 of the drive box 2. Further, the at least one rear wheel 4 is detachably mounted adjacent a second end 10 of the drive box 2, wherein the second end 10 of the drive box 2 is positioned opposite to the first end 9 across the drive box 2. To enable operation of the modular biking device, the plurality of pedals 6 and the at least one rear wheel 4 are operably coupled to the driving mechanism 5 in such a way that, the driving mechanism 5 transforms rotary motion of the plurality of pedals 6 about a pedaling axis 11 into rotary motion of the at least one rear wheel 4 about a drive axis 12. It should be noted that the plurality of pedals 6 and the at least one rear wheel 4 may be detachably mounted using any fastening technologies that are known to one of ordinary skill in the art, as long as the objectives of the present invention are fulfilled.

In order to accomplish the smooth functioning of the modular biking device, the present invention comprises many other components. To that end, the present invention comprises a head tube 13, a seat tube 14, a rear wheel port 15, and a stem 16. As seen in FIG. 1 and FIG. 3, the head tube 13 is connected to the first end 7 of the frame 1, and the stem 16 is mounted within the head tube 13. Further, as seen in FIG. 5 and FIG. 6, the rear wheel port 15 laterally traverses into the second end 8 of the frame 1, wherein the at least one rear wheel 4 is rotatably attached to the rear wheel port 15. Furthermore, the seat tube 14 is integrated into the frame 1 between the head tube 13 and the rear wheel port 15. As seen in FIG. 5, the seat tube 14 is positioned angularly offset from the drive box 2 and the seat tube 14 is terminally connected to the drive box 2. Preferably the head tube 13 and the seat tube 14 are tubular interconnecting segments that connect the frame 1 to the other functional pieces of the present invention. However, the head tube 13 and the seat tube 14 may comprise any other shape, size, location, orientation, components, and arrangement of components that are known to one of ordinary skill in the art, as long as the objectives of the present invention are not altered.

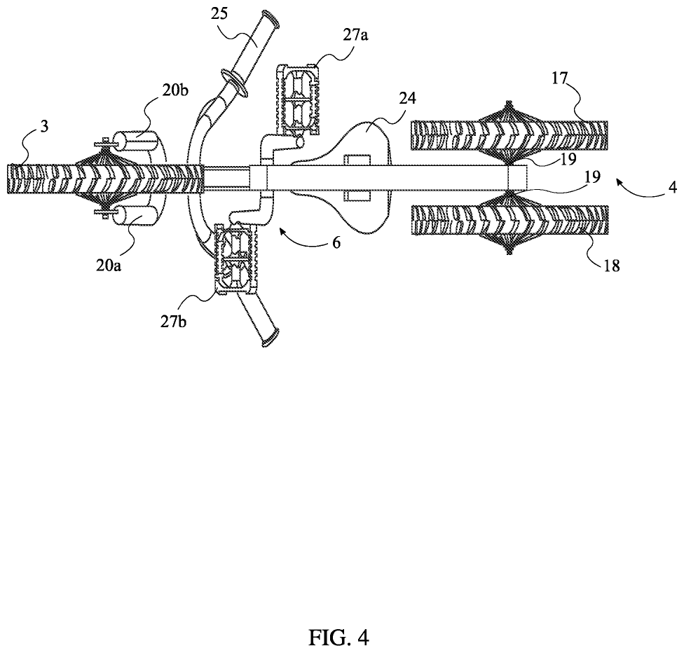

It is an aim of the present invention to enable users to transform the modular bike to various configurations by quickly releasing and snapping on the desired support attachments and wheels. For example, two rear wheels may be attached to the frame to transform the modular bike from a bicycle to a tricycle, thinner wheels may be swapped with thicker wheels to transform the modular bike from a road bike to a mountain bike etc. Accordingly, wherein the biking device is in a tricycle mode, the at least one rear wheel 4 comprises a first rear wheel 17 and a second rear wheel 18. As seen in FIG. 3, the first rear wheel 17 is positioned opposite to the second rear wheel 18 across the rear wheel port 15 of the frame 1. In order to make it easier to replace the at least one rear wheel 4, the first rear wheel 17 and the second rear wheel 18 are used on the right and left of the drive box 2 with the help of a continuous axle 19 that projects cantilevered on the right and left. In other words, the narrow drive box 2 comprises drive axles on the right and left of which two rear wheels are fastened with quick change mechanisms. Further, as seen in FIG. 3, and FIG. 4, when the biking device is in a tricycle mode, the drive box 2 comprising a planar body 2a. This is so that the at least one rear wheel 4 may be quickly replaced and there is symmetry in the arrangement of the at least one rear wheel 4. Furthermore, in this configuration, the present invention comprises a fork 20, wherein the fork 20 is terminally connected to a first end 21 the stem 16. The fork 20 is a typical construction for receiving wheels. Accordingly, the at least one front wheel 3 is rotatably mounted in between a first leg 20a of the fork 20 and a second leg 20b of the fork 20. More specifically, the at least one front wheel 3 is inserted in between the legs of the fork 20 and fastened on the outside on both sides with nuts or levers.

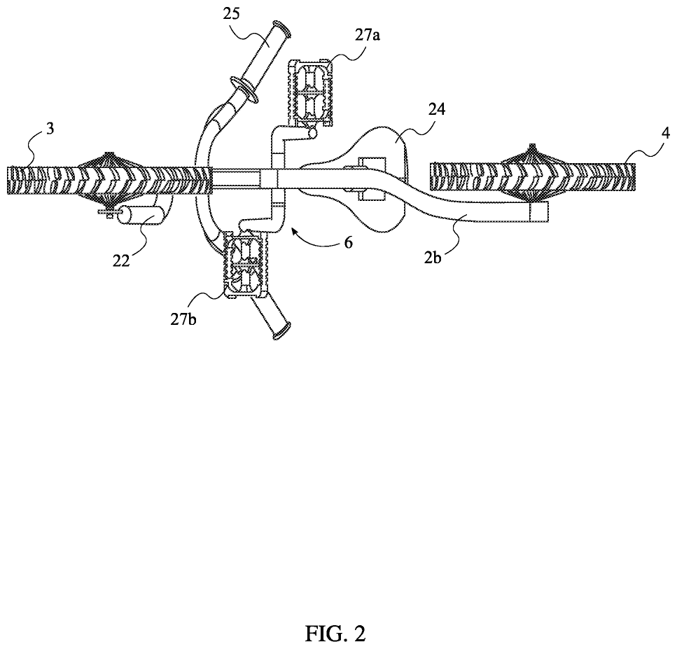

In reference to FIG. 1 and FIG. 2, wherein the biking device is in a bicycle mode, the present invention comprises a bent front leg 22. In this configuration, the bent front leg 22 is terminally connected to a first end 21 of the stem 16 and the at least one front wheel 3 is detachably mounted onto the bent front leg 22. In other words, in this configuration, the present invention has a quick-change front wheel. Further, when the biking device is in a bicycle mode, the drive box 2 comprises a bent body 2b, as seen in FIG. 1 and FIG. 2. This is so that, by bending the drive box 2 the rear wheel may be placed in the center line on a free-standing axle. In the conventional construction, wherein the wheel is mounted within a fork shaped frame, if the at least one rear wheel 4 is broken, it is very difficult and complicated to detach the rear wheel 4 from the frame 1. With the bent drive box 2b and a freely fixed axle, the at least one rear wheel 4 can be quickly removed and reinstalled. It should be noted that the at least one front wheel 3 and the at least one rear wheel 4 may be mounted onto the bent front leg 22 and the bent drive box 2b respectively by means of any fasteners or fastening techniques that are known to one of ordinary skill in the art, as long as the intents of the present invention are not altered. Examples of such fasteners include, but are not limited to a quick-change connection, a plugin connection, a screw-together connection, a flange-connection, welding connection, lever operated lock etc.

In order to provide comfort and a relaxing positioning for the cyclist/user, the present invention comprises a seat post 23, and a saddle 24. Preferably, the seat post 23 is positioned within the seat tube 14 and the saddle 24 is terminally connected to the seat post 23, opposite to the drive box 2. It should be noted that the saddle 24 and the seat post 23 may comprise any other shape, size, dimension, components and arrangement of components that are known to one of ordinary skill in the art, as long as the intents of the present invention are not altered. Further, in order to steer and maneuver the biking device, the present invention comprises a handlebar 25, wherein the handlebar 25 is terminally connected to a second end 26 of the stem 16, opposite to the at least one front wheel 3. Thus, this arrangement enables users to steer the handlebar 25, leading to steering of the at least one front wheel 3, so as to direct the biking device in a direction determined by the user.

As seen in FIG. 1 through FIG. 7, the plurality of pedals 6 comprises a first pedal 27a and a second pedal 27b. Preferably, the first pedal 27a extends laterally from a first surface 28 of the drive box 2 and the second pedal 27b extends laterally from a second surface 29 of the drive box 2, wherein the first surface 28 is positioned opposite to the second surface 29 across the drive box 2. This is so that, the first end 9 of the drive box 2 is coupled to the plurality of pedals 6 by a bar that extends through a position where a chain ring of the bicycle may be further coupled to each pedal arm of each pedal.

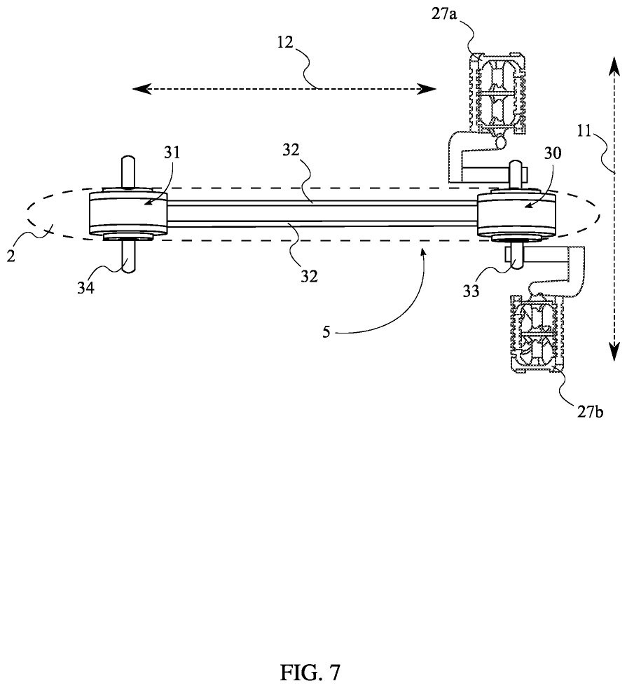

In the preferred embodiment of the present invention, the driving mechanism 5 is a hydraulic driving mechanism. To that end, the drive mechanism 5 comprises a hydraulic pump 30, a hydraulic motor 31, a plurality of fluid transfer tubes 32, a first continuous shaft 33, and a second continuous shaft 34. Preferably, the plurality of fluid transfer tubes 32 is connected between the hydraulic pump 30 and the hydraulic motor 31. Hydraulic mechanisms are typically powered by oil, but other liquids may be used as well. The plurality of fluid transfer tubes 32 enables pressurized oil to get pumped into the cylinder barrels in the hydraulic motor 31 and creates the power behind the motion. As seen in FIG. 7, the first continuous shaft 33 engages through the hydraulic pump 30 and the first continuous shaft 33 is connected in between the first pedal 27 and the second pedal 28. This is so that pedaling of the plurality of pedals 6 pumps the pressurized liquid into the hydraulic motor 31. To further transfer the power to the wheels, the second continuous shaft 34 engages through the hydraulic motor 31 and the second continuous shaft 34 is terminally connected to the at least one rear wheel 4. It should be noted that, any other connecting mechanism that is known to one of ordinary skill in the art may be employed for the smooth functioning of the hydraulic modular biking device.

In order to accomplish connection between the various components of the present invention to the drive box 2, the present invention comprises a first port 35 and a second port 36. As seen in FIG. 6, the first port 35 is positioned adjacent the first end 9 of the drive box 2 and the second port 36 is positioned adjacent the second end 10 of the drive box 2. This is so that the plurality of pedals 6 is detachably connected to the driving mechanism 5 through the first port 35 and the at least one rear wheel 4 is detachably connected to the driving mechanism 5 through the second port 36. In other words, the first port 35 and the second port 36 act as attachment points for connecting the plurality of pedals 6 and the at least one rear wheel 4 to the driving mechanism 5. However, any other mode of connection may be employed, as long as the intents of the present invention are not altered.

Although the invention has been explained in relation to its preferred embodiment, it is to be understood that many other possible modifications and variations can be made without departing from the spirit and scope of the invention as hereinafter claimed.

What is claimed is:

1. A modular biking device, comprising:
a frame;
a drive box;
at least one front wheel
at least one rear wheel;
a driving mechanism;
a plurality of pedals;
the drive box being detachably connected between the frame and the at least one rear wheel;
the at least one front wheel being detachably mounted to a first end of the frame;
the at least one rear wheel being detachably mounted onto a second end of the frame, opposite to the front wheel;
the driving mechanism being mounted within the drive box;
the plurality of pedals being detachably mounted adjacent a first end of the drive box;
the at least one rear wheel being detachably mounted adjacent a second end of the drive box, wherein the second end is positioned opposite to the first end across the drive box; and
the plurality of pedals and the at least one back wheel being operably coupled to the driving mechanism, wherein the driving mechanism transforms rotary motion of the pedals about a pedaling axis into rotary motion of the at least one rear wheel about a drive axis.

2. The biking device of claim 1, comprising:
a head tube;
a seat tube;
a rear wheel port;
a stem;
the head tube being connected to the first end of the frame;
the rear wheel port laterally traversing into the second end of the frame;
the seat tube being integrated into the frame between the head tube and the rear wheel port;
the rear wheel being rotatably attached to the rear wheel port;
the seat tube being positioned angularly offset from the drive box;
the seat tube being terminally connected to the drive box; and
the stem being mounted within the head tube.

3. The biking device of claim 2, comprising;
wherein the biking device is in a tricycle mode:
the at least one rear wheel comprising a first rear wheel and a second rear wheel; and
the first rear wheel being positioned opposite to the second rear wheel across the rear wheel port.

4. The biking device of claim 2, comprising;
a fork:
the fork being terminally connected to a first end the stem; and
the at least one front wheel being rotatably mounted in between a first leg of the fork and a second leg of the fork.

5. The biking device of claim 2, comprising;
wherein the biking device is in a bicycle mode:
a bent front leg;
the bent front leg being terminally connected to a first end of the stem; and
the at least one front wheel being detachably mounted onto the bent front leg.

6. The biking device of claim 2, comprising:
a seat post;
a saddle;
the seat post being positioned within the seat tube; and
the saddle being terminally connected to the seat post, opposite to the drive box.

7. The biking device of claim 2, comprising:
a handle bar; and
the handle bar being terminally connected to a second end of the stem, opposite to the at least one front wheel.

8. The modular biking device of claim 1, wherein the biking device is in a tricycle mode, the drive box comprising a planar body.

9. The modular biking device of claim 1, wherein the biking device is in a bicycle mode, the drive box comprising a bent body.

10. The modular biking device of claim 1, comprising:
the plurality of pedals comprising a first pedal and a second pedal;
the first pedal extending laterally from a first surface of the drive box; and
the second pedal extending laterally from a second surface of the drive box, wherein the first surface is positioned opposite to the second surface across the drive box.

11. The biking device of claim 10, comprising:
the drive mechanism comprising a hydraulic pump, a hydraulic motor, a plurality of fluid transfer tubes, a first continuous shaft, a second continuous shaft;
the plurality of fluid transfer tubes being connected between the hydraulic pump and the hydraulic motor;
the first continuous shaft engaging through the hydraulic pump;
the first continuous shaft being connected in between the first pedal and the second pedal;
the second continuous shaft engaging through the hydraulic motor;
the second continuous shaft being terminally connected to the at least one rear wheel.

12. The biking device of claim 1, the drive box comprising:
a first port;
a second port;
the first port being positioned adjacent the first end of the drive box;
the second port being positioned adjacent the second end of the drive box;
the plurality of pedals being detachably connected to the driving mechanism through the first port; and
the at least one rear wheel being detachably connected to the driving mechanism through the second port.

13. A modular biking device, comprising:
a frame;
a drive box;
at least one front wheel
at least one rear wheel;
a driving mechanism;
a plurality of pedals;
the plurality of pedals comprising a first pedal and a second pedal;
the drive box being detachably connected between the frame and the at least one rear wheel;
the at least one front wheel being detachably mounted to a first end of the frame;
the at least one rear wheel being detachably mounted onto a second end of the frame, opposite to the front wheel;
the driving mechanism being mounted within the drive box;
the plurality of pedals being detachably mounted adjacent a first end of the drive box;
the at least one rear wheel being detachably mounted adjacent a second end of the drive box, wherein the second end is positioned opposite to the first end across the drive box;
the first pedal extending laterally from a first surface of the drive box; and
the second pedal extending laterally from a second surface of the drive box, wherein the first surface is positioned opposite to the second surface across the drive box; and
the plurality of pedals and the at least one back wheel being operably coupled to the driving mechanism, wherein the driving mechanism transforms rotary motion of the pedals about a pedaling axis into rotary motion of the at least one rear wheel about a drive axis.

14. The biking device of claim 13, comprising:
the drive mechanism comprising a hydraulic pump, a hydraulic motor, a plurality of fluid transfer tubes, a first continuous shaft, a second continuous shaft;
the plurality of fluid transfer tubes being connected between the hydraulic pump and the hydraulic motor;
the first continuous shaft engaging through the hydraulic pump;
the first continuous shaft being connected in between the first pedal and the second pedal;
the second continuous shaft engaging through the hydraulic motor;
the second continuous shaft being terminally connected to the at least one rear wheel.

15. The biking device of claim 13, comprising:
a head tube;
a seat tube;
a rear wheel port;
a stem;
the head tube being connected to the first end of the frame;
the rear wheel port laterally traversing into the second end of the frame;
the seat tube being integrated into the frame between the head tube and the rear wheel port;
the rear wheel being rotatably attached to the rear wheel port;
the seat tube being positioned angularly offset from the drive box;
the seat tube being terminally connected to the drive box; and
the stem being mounted within the head tube.

16. The biking device of claim 15, comprising;
wherein the biking device is in a tricycle mode:
the at least one rear wheel comprising a first rear wheel and a second rear wheel;
a fork;
the first rear wheel being positioned opposite to the second rear wheel across the rear wheel port;
the fork being terminally connected to a first end the stem; and
the at least one front wheel being rotatably mounted in between a first leg of the fork and a second leg of the fork.

17. The biking device of claim 15, comprising;
wherein the biking device is in a bicycle mode:
a bent front leg;
the bent front leg being terminally connected to a first end of the stem; and
the at least one front wheel being detachably mounted onto the bent front leg.

18. The biking device of claim 15, comprising:
a seat post;
a saddle;
a handle bar;
the seat post being positioned within the seat tube;
the saddle being terminally connected to the seat post, opposite to the drive box; and
the handle bar being terminally connected to a second end of the stem, opposite to the at least one front wheel.

19. The biking device of claim 13, the drive box comprising:
a first port;
a second port;
the first port being positioned adjacent the first end of the drive box;
the second port being positioned adjacent the second end of the drive box;
the plurality of pedals being detachably connected to the driving mechanism through the first port; and
the at least one rear wheel being detachably connected to the driving mechanism through the second port.
